(19) United States
(12) Patent Application Publication
(10) Pub. No.: US 2005/0067427 A1
(43) Pub. Date: Mar. 31, 2005

(54) Retail exposure dispensing machine

(76) Inventors: Carolyn Ann Clark, New Albany, OH (US); Samuel Andonna Clark, New Albany, OH (US); Daniel Steven Clark, New Albany, OH (US)

Correspondence Address: CAROLYN, SAM AND DAN CLARK, 5037 BABBITT RD., NEW ALBANY, OH, 43054, US

(21) Appl. No.: 10/429,981

(22) Filed: Sep. 30, 2003

(51) Int. Cl. B65G 59/00

(52) U.S. Cl. 221/129

(57) ABSTRACT

The Retail Exposure Dispensing Machine is unique in that it can conveniently distribute most small products sold in retail establishments today using little shelf space while holding a lot of product. It continuously displays the product allowing the package advertising to do its' job. Distribution is enabled by pulling a handle connected to a pull slide which will dispense only one unit. Each succeeding pull will dispense one unit until the whole dispenser is empty. Distribution tabs on the mechanical slide allow the dispensing of one unit at a time row after row of product. If a partial pull is enacted and it does not grab another product to give out it will correct itself within one additional full pull. Due to the shelf space saving nature along with its' compact high capacity storage this unique product will have universal appeal!

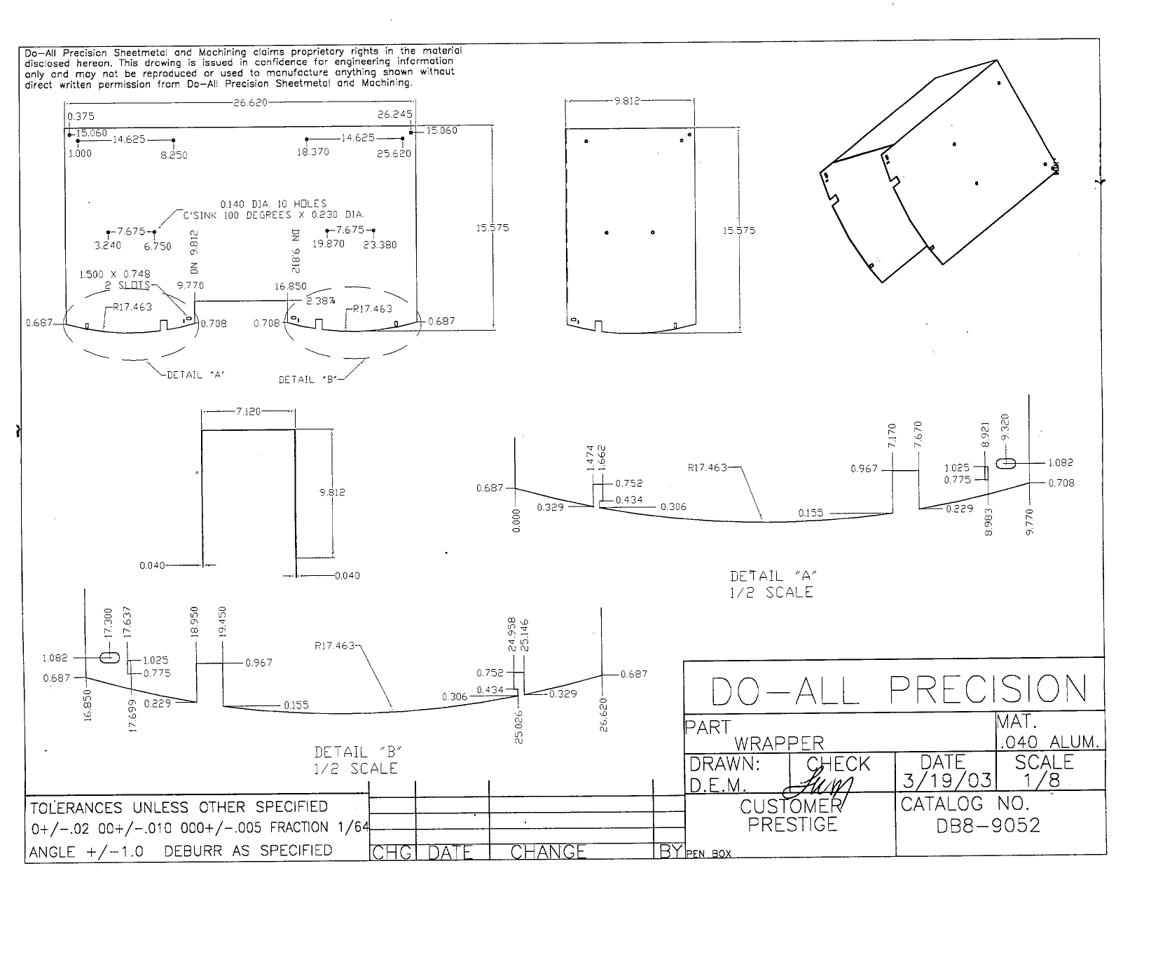

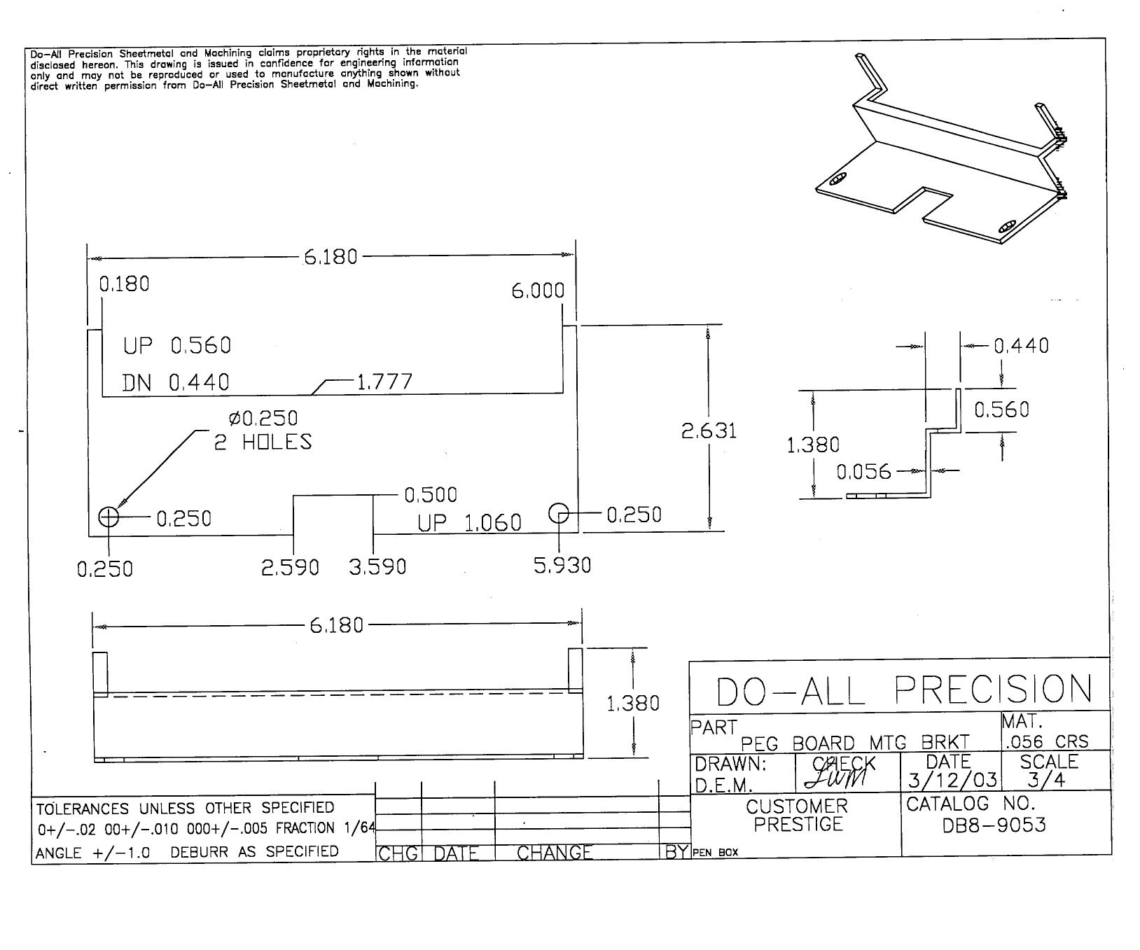

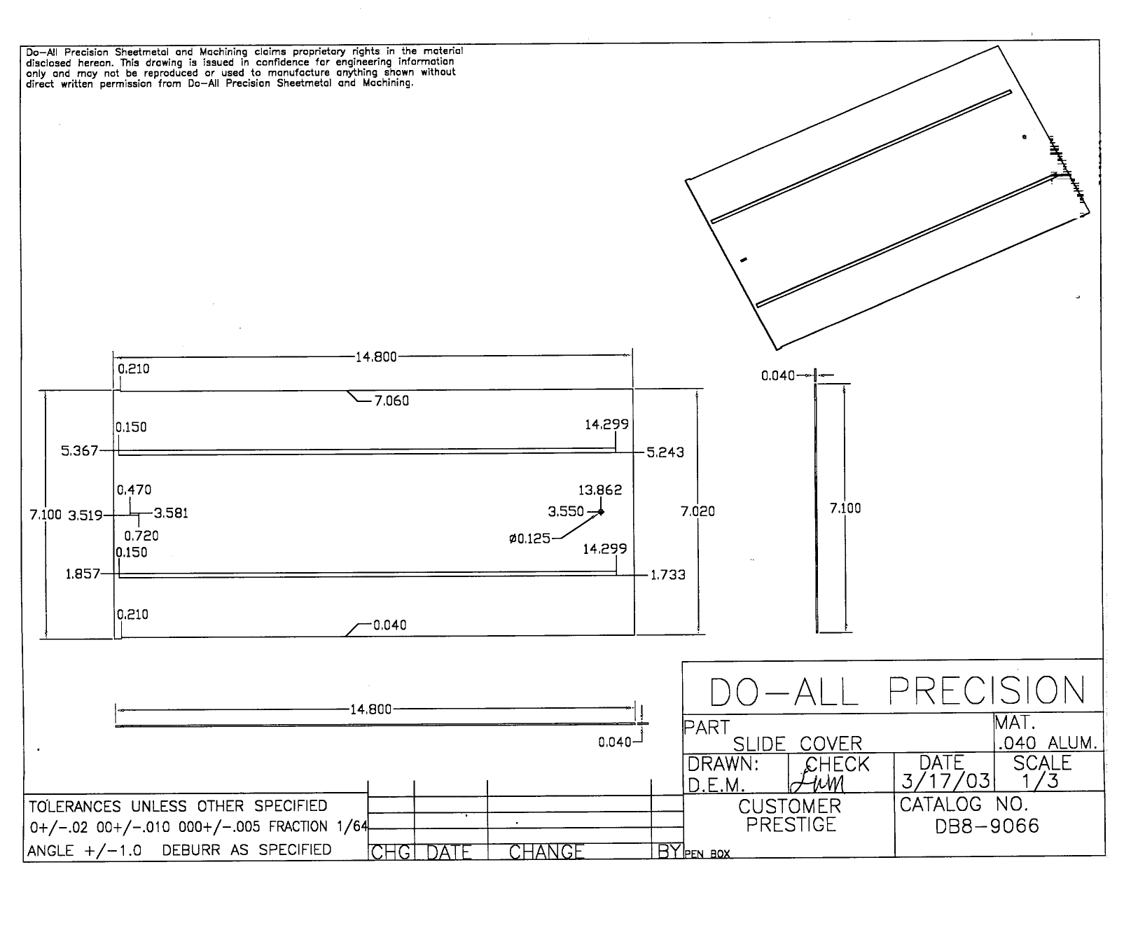

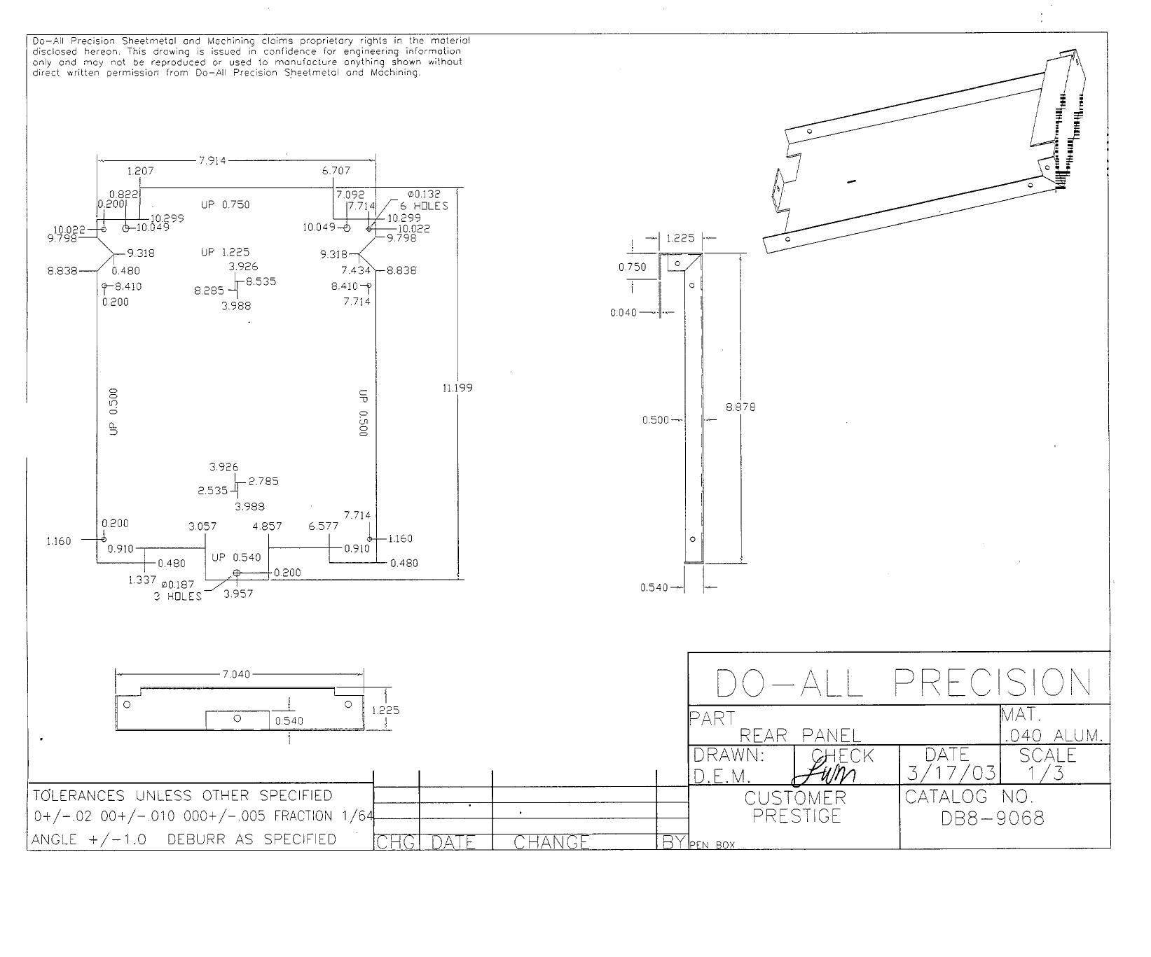

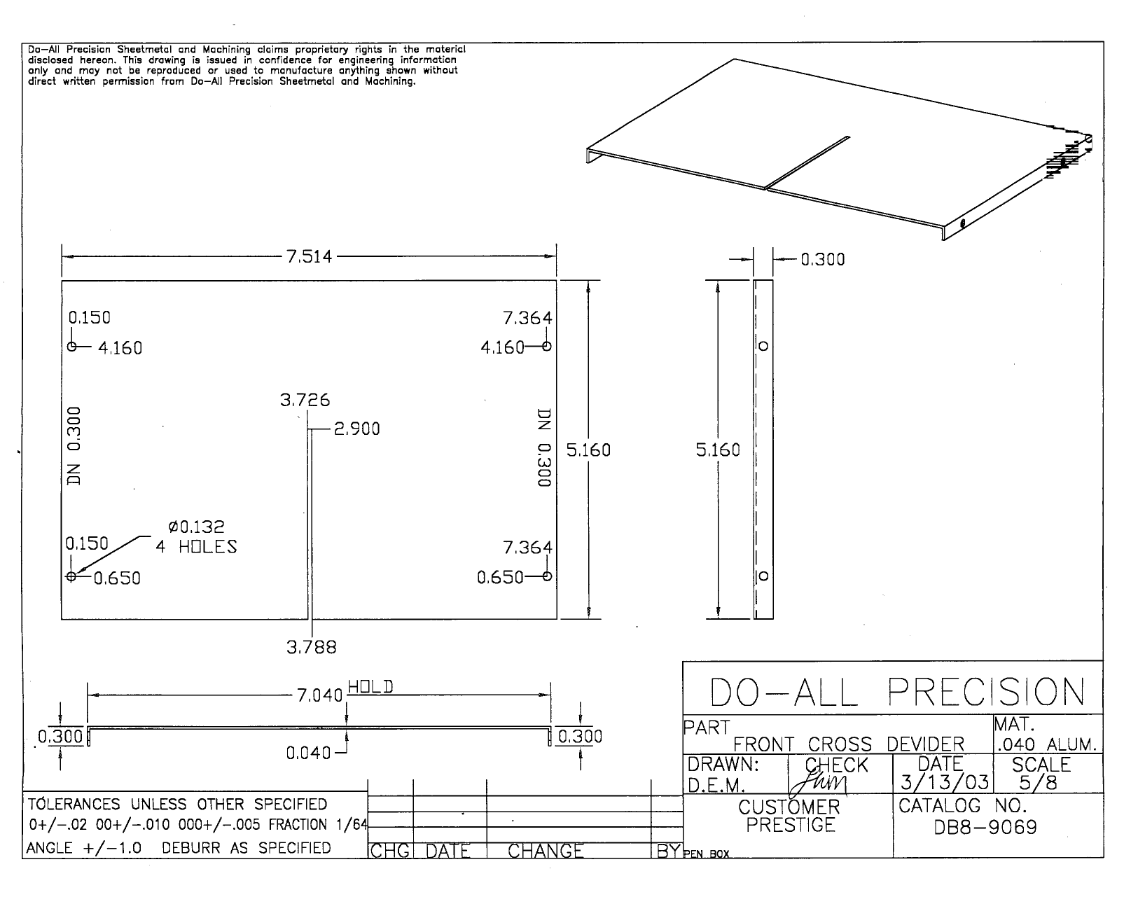

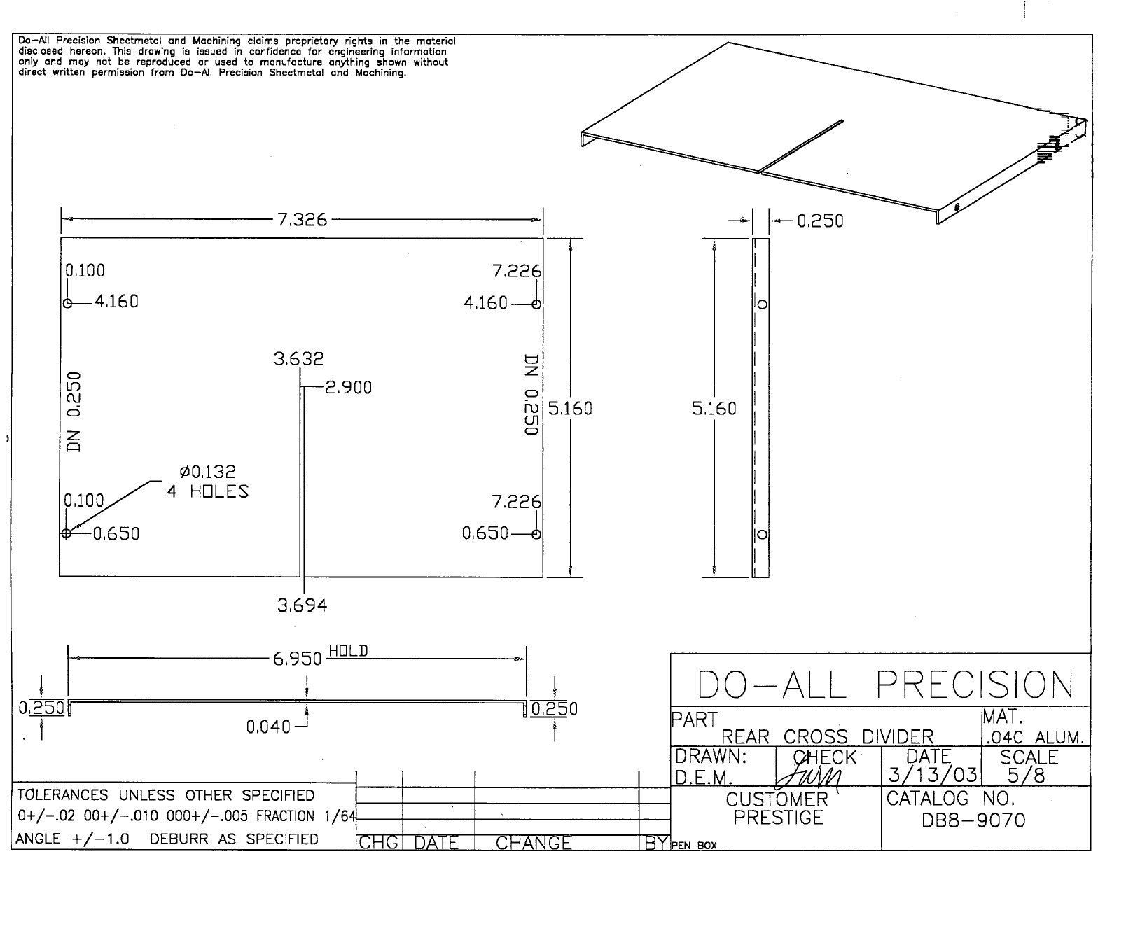

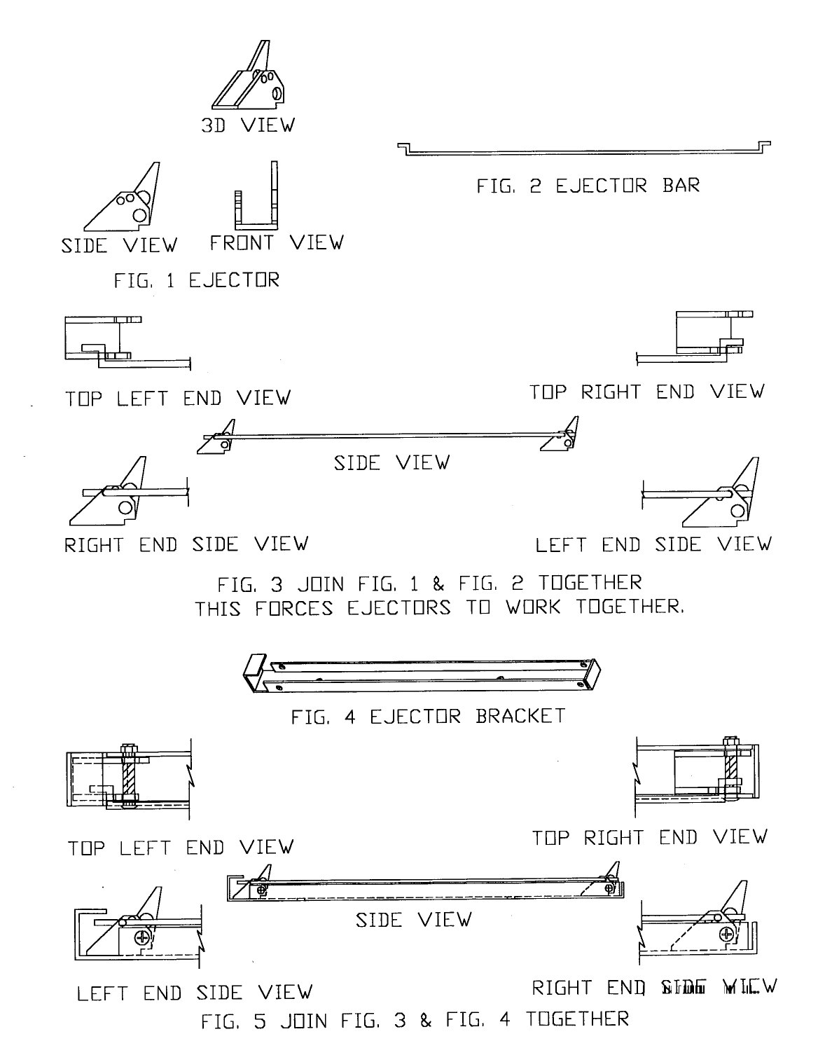

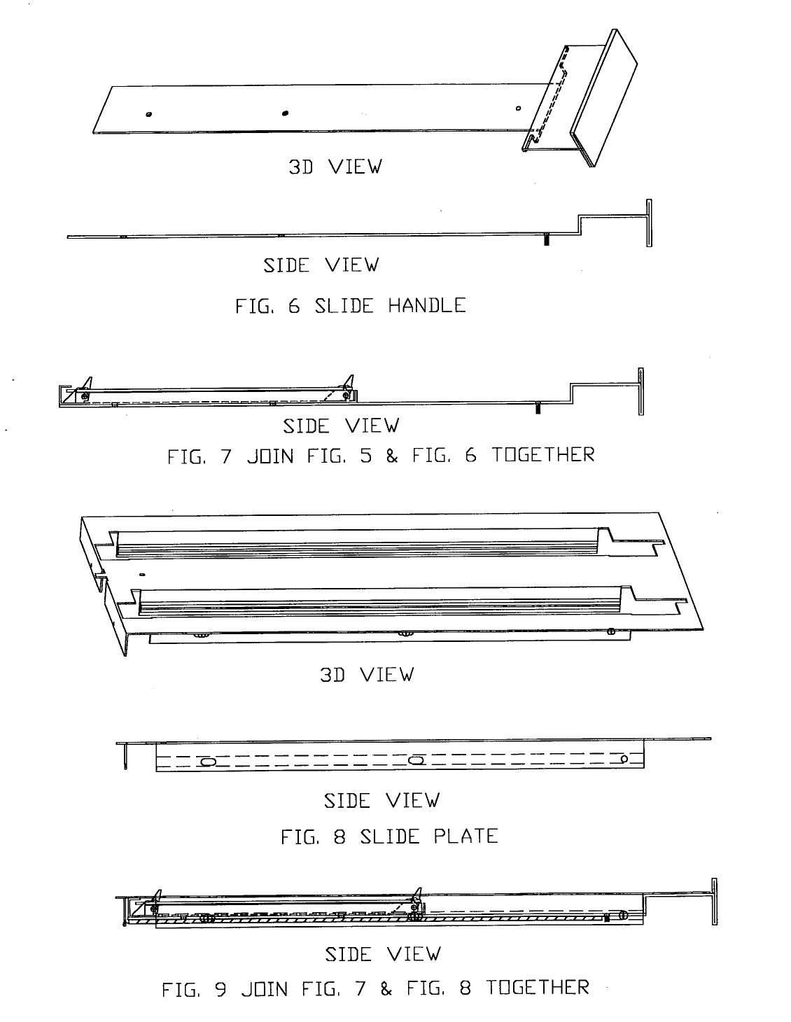

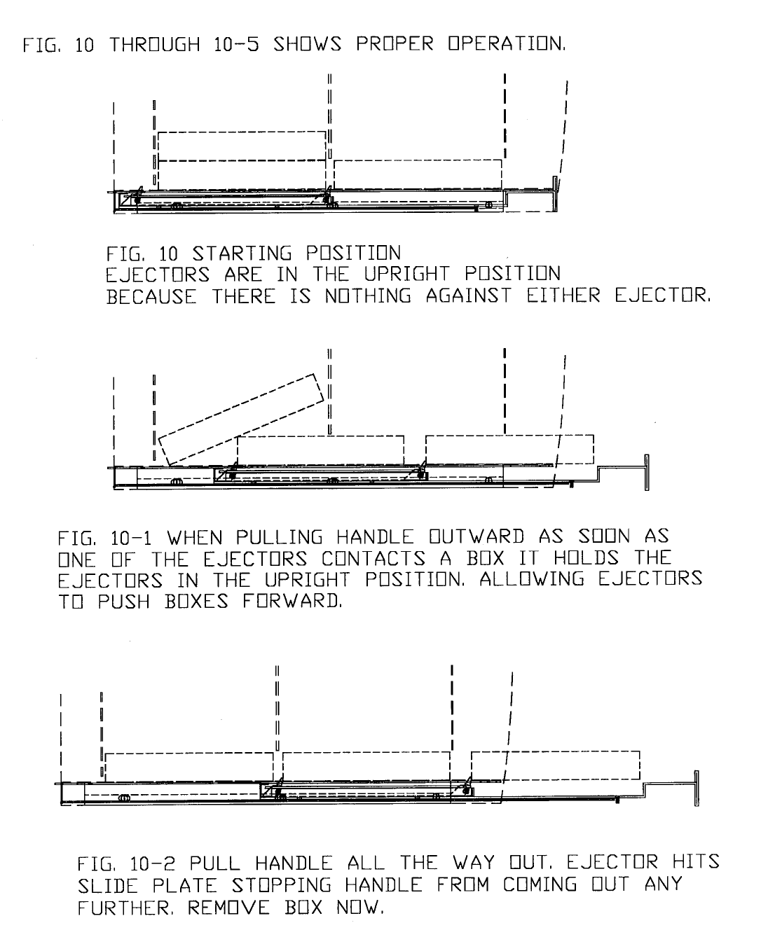

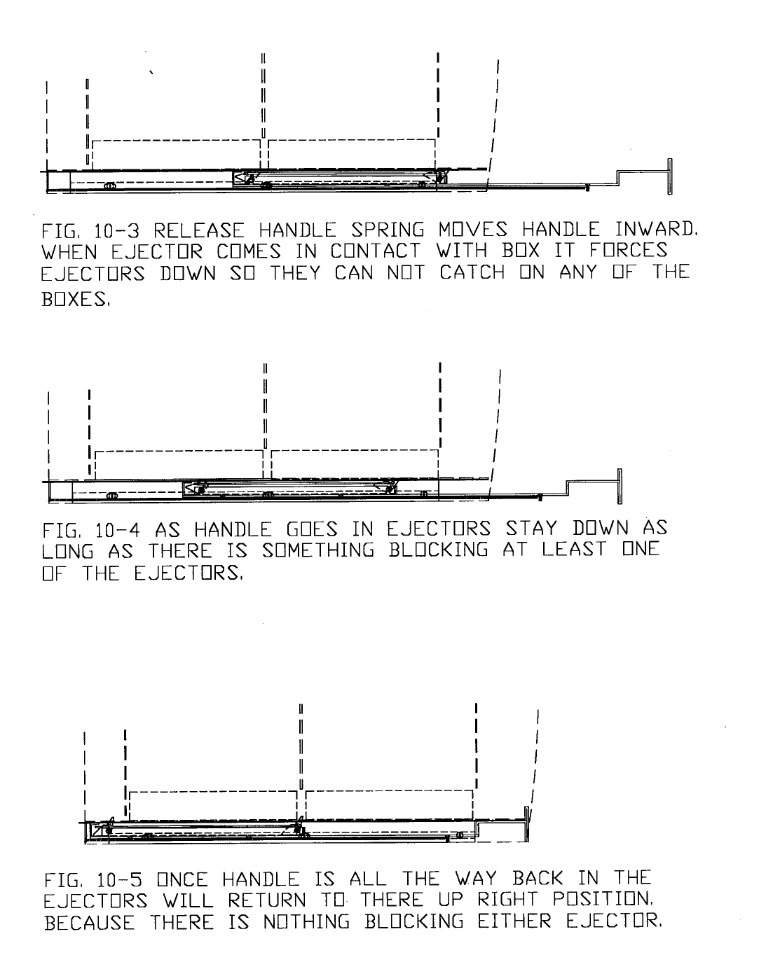

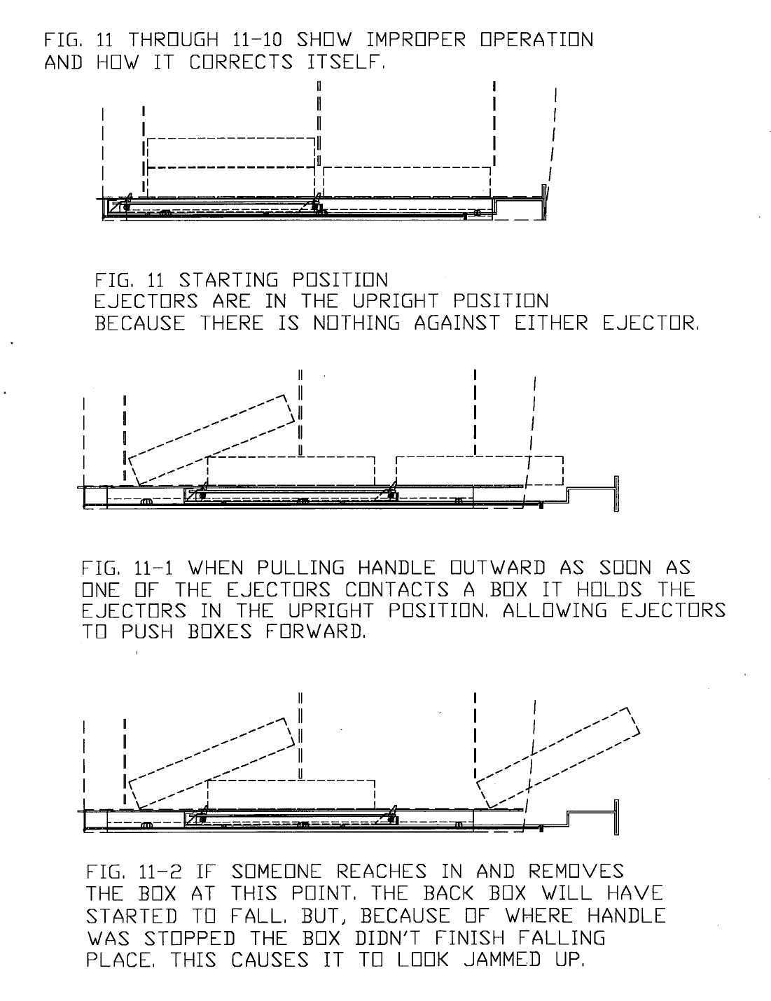

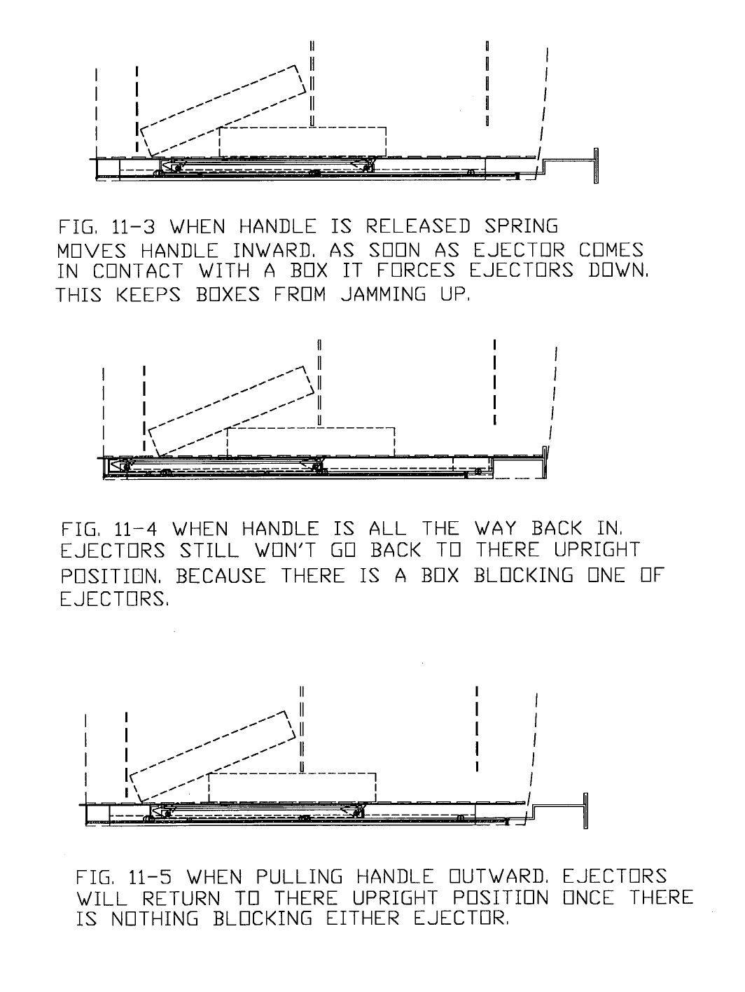

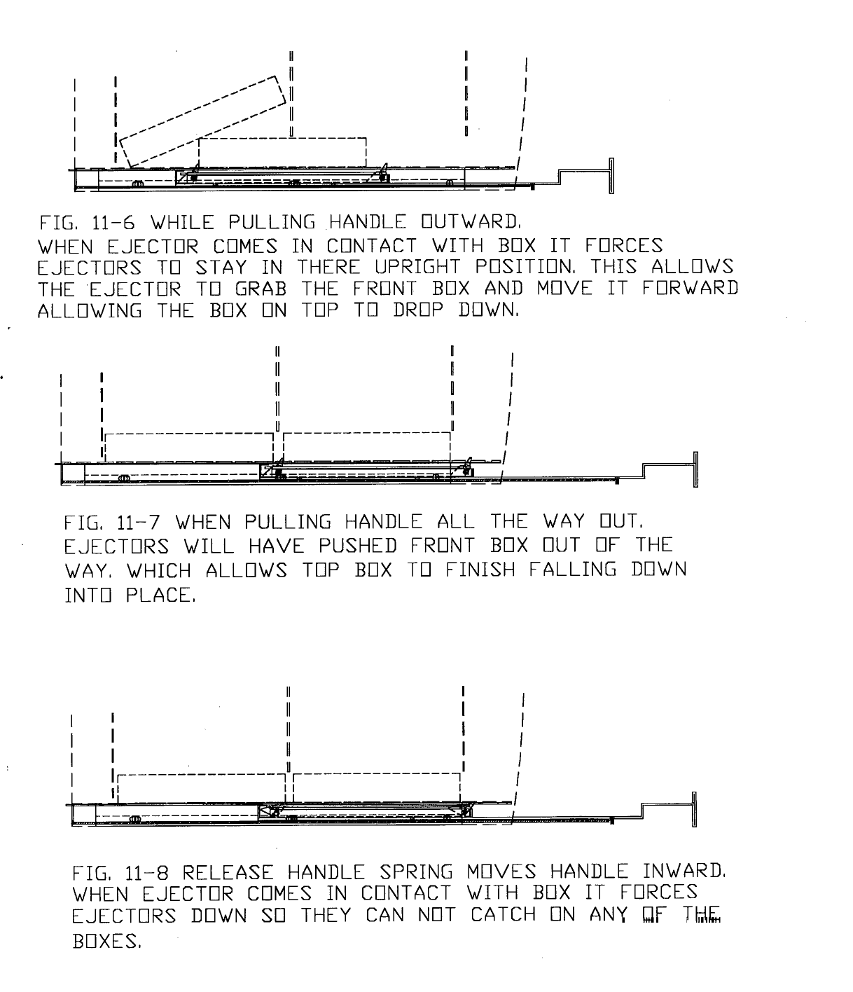

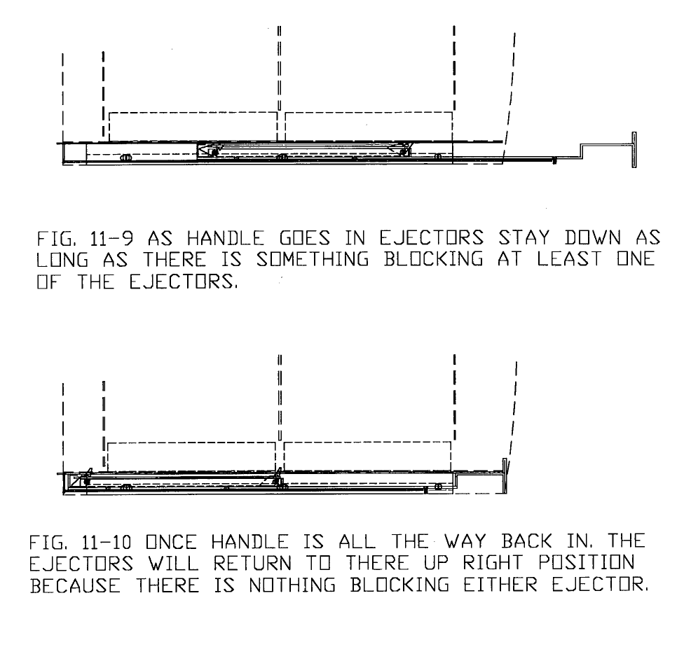

This application is for a patent for a dispensing machine that is capable of dispensing most smaller items sold in retail stores today.

The dispenser is unique because once it is loaded, which can be done from the top or thru access doors in the front or center, it distributes the product from the back. The product moves forward enabling it to always be displayed right in the front of the unit. This is very important for retail exposure. The unit also allows us to distribute much more product in the same amount of retail wall and/or counter space. The product is distributed using a mechanical/manual pull slide that distributes one product per each pull cycle or several products per pull cycle depending on the needs of the end user. Each time the slide is pulled it takes product and/or products that are stacked in the rear compartments and moves it forward forcing the front row to distribute until the rear compartment is empty. It then starts taking product from the next most forward compartment until all compartments are empty. The slide on this unit is also very unique due to the fact that the distribution tabs that are attached to the mechanical/manual slide move up and down via gravity allowing product to be moved forward then retracting to pass back under the product remaining in the dispensing unit which is now ready to cycle again. The distribution tabs are linked together to function in sequence which is critical to the operation of the dispenser. Without the mechanical linking of the tabs the dispensing unit would jam if the mechanical/manual slide was not fully extended by the consumer. The linking of the distribution tabs together to work in sequence allows the dispensing unit to actually correct itself with one cycle of the mechanical/manual slide. This self-correcting feature is unique and allows the unit to distribute product continually with little to no maintenance. The unit can be built from numerous types of materials including but not limited to ferrous or nonferrous metals, a combination of both, plastics, acrylics or wood.

| Catalog # | Title | Description |
|---|---|---|
| DB8-9052 | Wrapper, | Instructions for the manufacture of |
| | | the outer shell. |
| DB8-9053 | Mounting Bracket, | Used to mount the unit on display |
| | | wall. |
| DB8-9066 | Slide Cover, | Covers moving parts. |
| DB8-9068 | Rear Panel, | Back cover. |
| DB8-9069 | Front Cross Divider, | Front strengthening panel. |
| DB8-9070 | Rear Cross Divider, | Rear-strengthening panel. |

1-8 Intricate parts page, Description of small parts used in unit.
2-8 Slide and Associated Parts, Slide workings.
3-8 Unit Operation Description, Demonstrates unit operation.
4-8 Unit Operation Description, Continuation of previous page.
5-8 Unit Operation Description, Continuation of previous page.
6-8 Unit Operation Description, Continuation of previous page.
7-8 Unit Operation Description, Continuation of previous page.
8-8 Unit Operation Description, Continuation of previous page.

1. An enclosure for dispensing small retail items that once loaded will allow the package advertising to always be displayed while automatically moving fresh product forward after each purchase.
